(19) United States
(12) Patent Application Publication
(10) Pub. No.: US 2013/0139184 A1
(43) Pub. Date: May 30, 2013

(54) METHOD FOR EMBEDDING A HOST DRIVER WITHIN A DEVICE

(71) Applicants: Matthew K. Freel, Colorado Springs, CO (US); Jason C. McGinley, Castle Rock, CO (US); Brett J. Henning, Colorado Springs, CO (US); Scott W. Dominguez, Colorado Springs, CO (US); Sagar G. Gadsing, Colorado Springs, CO (US)

(72) Inventors: Matthew K. Freel, Colorado Springs, CO (US); Jason C. McGinley, Castle Rock, CO (US); Brett J. Henning, Colorado Springs, CO (US); Scott W. Dominguez, Colorado Springs, CO (US); Sagar G. Gadsing, Colorado Springs, CO (US)

(73) Assignee: LSI CORPORATION, Milpitas, CA (US)

(21) Appl. No.: 13/307,747

(22) Filed: Nov. 30, 2011

(51) Int. Cl. G06F 9/44

(52) U.S. Cl. 719/327

(57) ABSTRACT

The present invention is directed to a method of operation of a host system by which the host system obtains a driver necessary for running a device (ex.—peripheral device, such as a USB stick, printer, etc.) connected to the host system in an operating system of the host system. In the method(s) disclosed herein, the driver (ex.—host driver) is embedded within in an on-board memory of the device itself. The host system queries the device to determine if and where within the device the driver is located and uploads the driver from the peripheral device. This promotes improved efficiency since the host does not have to store drivers it may not need, but can just obtain the driver from the peripheral device once the peripheral device is connected to the host.

### FIELD OF THE INVENTION

The present invention relates to the field of drivers (ex.—software drivers) and particularly, to a method for embedding a host driver within a device.

### BACKGROUND OF THE INVENTION

Currently available data storage systems and methods may not provide a desired level of efficiency with regards to driver management.

Therefore, it may be desirable to provide a method which addresses the above-referenced shortcomings of currently available solutions.

### SUMMARY OF THE INVENTION

Accordingly, an embodiment of the present disclosure is directed to a method of operation of a host system, the method including: determining if a desired driver is present within the host system; when the desired driver is not present within the host system, directing a query to a device connected to the host system to determine if the desired driver is present within on-board memory of the device; receiving a response to the query, the response being provided by the device, the response indicating that the desired driver is present within the on-board memory of the device; based upon the received response, determining a location within the on-board memory of the device where the desired driver on the device is stored; uploading the desired driver from the determined location of the on-board memory of the device to the host system; loading the desired driver via an operating system of the host system; communicating with the device via the operating system of the host system by utilizing the desired driver; downloading an updated version of the desired driver from a disk or via the Internet to the host system; identifying the updated version of desired driver; selecting the identified updated version of the desired driver; and downloading the updated version of the desired driver from the host system to the device.

A further embodiment of the present disclosure is directed to a non-transitory, computer-readable medium having computer-executable instructions for performing a method of operation of a host system, said method including: determining if a desired driver is present within the host system; when the desired driver is not present within the host system, directing a query to a device connected to the host system to determine if the desired driver is present within on-board memory of the device; receiving a response to the query, the response being provided by the device, the response indicating that the desired driver is present within the on-board memory of the device; based upon the received response, determining a location within the on-board memory of the device where the desired driver on the device is stored; uploading the desired driver from the determined location of the on-board memory of the device to the host system; loading the desired driver via an operating system of the host system; communicating with the device via the operating system of the host system by utilizing the desired driver; downloading an updated version of the desired driver from a disk or via the Internet to the host system; identifying the updated version of desired driver; selecting the identified updated version of the desired driver; and downloading the updated version of the desired driver from the host system to the device.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figure(s) in which:

FIG. 1 is a block diagram illustration of a data storage system/data handling system in accordance with an exemplary embodiment of the present disclosure; and

FIG. 2 is a flowchart which illustrates a method of operation of a host system of the data handling system shown in FIG. 1, in accordance with exemplary embodiments of the present disclosure.

### DETAILED DESCRIPTION OF THE INVENTION

Reference will now be made in detail to the presently preferred embodiments of the invention, examples of which are illustrated in the accompanying drawings.

Currently available operating systems may be pre-packaged with drivers for popular devices. These pre-packaged drivers allow the operating system (OS) to automatically configure and use devices that it finds. With these currently available operating systems, a user must manually install device drivers that are not pre-packaged within the OS. This will happen with any device that is created after the OS is created. The method(s) of the present disclosure remove(s) the necessity for the OS to pre-package drivers. The method(s) of the present disclosure also remove(s) the necessity for users to manually install drivers.

Most devices that are used by currently available operating systems require a driver specific for that device. For example, if a USB flash stick is plugged in, the OS will discover that device and determine if it has a driver available to load. If the OS has a driver that corresponds to this device, then the device may be configured and used. However, if the OS does not have a driver, the device cannot be used until the user manually loads a driver. The method(s) of the present disclosure allow(s) for a usable driver to be stored on the device itself so that the device is always usable, regardless of whether or not the OS has a driver for the device.

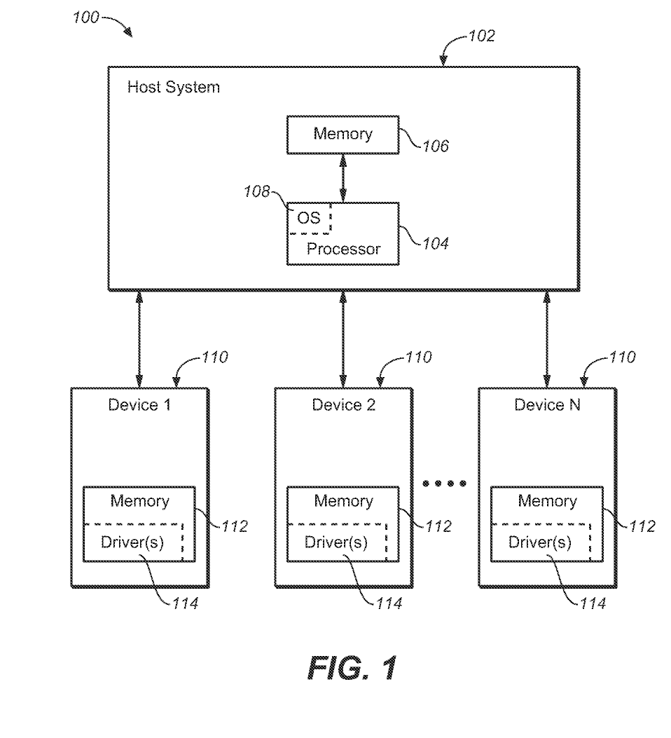

Referring to FIG. 1, a system 100 (ex.—data storage system; data handling system) in accordance with an exemplary embodiment of the present disclosure is shown. In exemplary embodiments of the present disclosure, the system 100 may include a host computer (ex.—a host system; a host) 102. Further, the host system 102 may include a processor 104. Still further, the host computer 102 may include a memory 106. For example, the memory 106 may be or may include hard disk drive(s), Random Access Memory (RAM), etc. Further, the processor 104 and memory 106 may be connected to (ex.—communicatively coupled with) each other.

In an embodiment of the present disclosure, the host system 102 may include an operating system 108. In exemplary embodiments of the present disclosure, the operating system 108 may be a set of programs (ex.—software programs; system software) configured for managing computer hardware resources and providing common services for application software. Further, the operating system 108 may be configured for executing on the processor 104 of the host system 102. Still further, the system 100 may include one or more devices 110, the one or more devices 110 being connected to (ex.—communicatively coupled with) the host system 102. Further, the devices (ex.—external devices) 110 may each be configured with on-board (ex.—non-volatile) memory 112. For instance, the devices 110 may include (but are not limited to): printers; video adapters; network cards; sound cards; host bus adapter (HBA) cards; image scanners; digital cameras; buses (ex.—for pointing devices); Universal Serial Bus (USB) devices (ex.—USB mice, USB keyboards, and/or USB flash sticks); and/or a device(s) which may be directly connected to (ex.—plugged into port(s) of) the host system.

In exemplary embodiments of the present disclosure, one or more drivers (ex.—host drivers; device drivers) 114 may be stored in (ex.—embedded in) the on-board memory 112 of the devices 110. For instance, the driver(s) 114 may be software which is necessary to allow the device(s) 110 to operate and to interact with (ex.—to be run in; to be run with; to be used by; to be configured by) the operating system 108 of the host system 102. Further, the driver(s) 114 may be software which is specific for (ex.—corresponds to) the device 110 upon which it is stored.

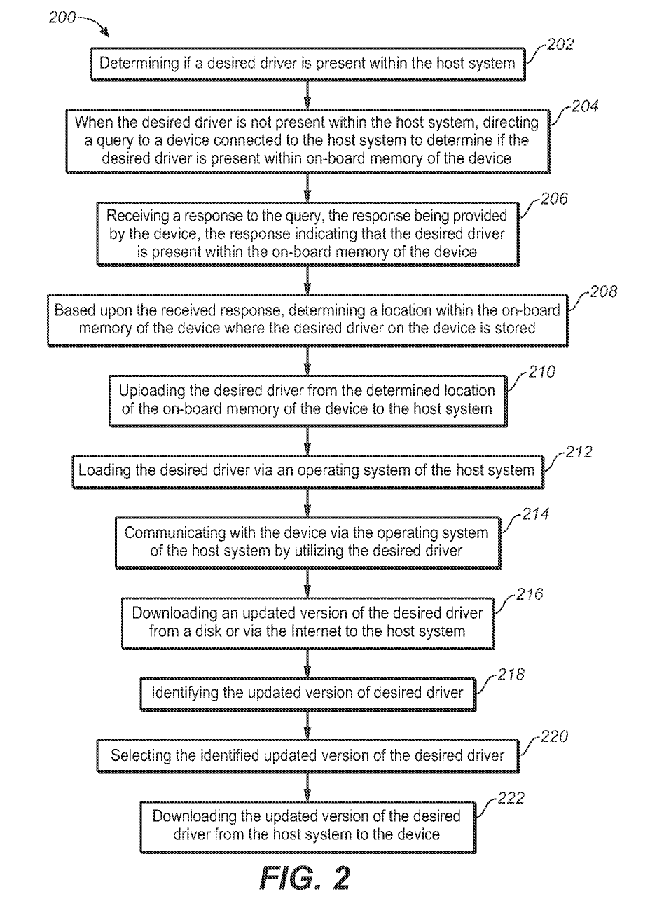

FIG. 2 is a flowchart which illustrates a method of operation for a host system 102, such as described above (and shown in FIG. 1), in accordance with an embodiment of the present disclosure. In exemplary embodiments of the present disclosure, the method 200 may include the step of determining if a desired driver (ex.—host driver; device driver) is present within the host system 202. For example, the host 102 may check its memory 104 to determine if it contains the desired driver. The method 200 may further include the step of, when the desired driver is not present within the host system, directing a query to a device connected to the host system to determine if the desired driver is present within on-board memory of the device 204. For instance, when the desired driver is not present within the host system, the host 102 may direct queries to (ex.—may query) one or more devices 110 (ex.—printers; video adapters; network cards; sound cards; host bus adapter (HBA) cards; image scanners; digital cameras; buses (ex.—for pointing devices); Universal Serial Bus (USB) devices (ex.—USB mice, USB keyboards, and/or USB flash sticks) which are connected to (ex.—directly connected to; plugged into port(s) of) the host system 100.

In further embodiments, the method 200 may further include the step of receiving a response to the query, the response being provided by the device, the response indicating that the desired driver is present within the on-board memory of the device 206. The method 200 may further include the step of, based upon the received response, determining a location within the on-board memory of the device where the desired driver on the device is stored 208. The method 200 may further include the step of uploading the desired driver from the determined location of the on-board memory of the device to the host system 210. For instance, if the device 110 includes a driver 114 (ex.—host driver; device driver) which is supported by the host 102, the host 102 may obtain/receive (ex.—upload) the driver 114 from the device 110.

In exemplary embodiments, the method 200 may further include the step of loading the desired driver via an operating system of the host system 212. The method 200 may further include the step of communicating with the device via the operating system of the host system by utilizing the desired driver 214. The method 200 may further include the step of downloading an updated version of the desired driver from a disk or via the Internet to the host system 216.

In embodiments of the present disclosure, the method 200 may further include the step of identifying the updated version of desired driver 218. The method 200 may further include the step of selecting the identified updated version of the desired driver 220. The method 200 may further include the step of downloading the updated version of the desired driver from the host system to the device 222. For example, the host system 102 may identify the new (ex.—updated) version of the driver and may download it to the device 110, thereby allowing the device 110 to contain the updated (ex.—latest) version of the driver.

In the system(s) and method(s) of the present disclosure, software (ex.—drivers) necessary for running the device(s) 110 in operating system(s) 108 may be stored on the device(s) 110 themselves. This allows for true plug-and-play use and may provide a few advantages over currently available solutions. A first advantage is that the OS 108 does not have to save drivers for devices it may never see, thereby promoting reduction in wasted disk space on the hard drive 106, as well as on the install media. A further advantage is that a user does not have to possess or find the correct driver for the device, thereby saving time and aggravation for the user when using a new device. Still further, if a user ever chooses to download a new (ex.—updated version of the) driver (ex.—host driver; device driver) to the host system 102, the updated version of the driver can be provided from the host system 102 to the device 110 (ex.—may be downloaded from the host 102 to the device 110; may be loaded onto the device 110). Thus, when moving the device 110 from one host system 102 to another host system (ex.—when disconnecting the device 110 from one host system and connecting the device to another host system), the latest driver is taken along, thereby eliminating the need to update each host system since the device may serve as its own update source.

Due to the nature of embedding a driver (ex.—a host driver; device driver) within a device, this concept may be utilized by nearly any device that is plugged into a host system. Considering most devices contain some type of on-board memory, and that memory capacity is growing while prices are dropping, storing a driver (ex.—host driver; device driver) on the device may essentially be done for free. The host system simply needs a way to query the device and to understand if the device contains an embedded driver and, if so, the location from which to upload it. This may be achieved in many different ways in that a standard may be developed or a component may be added to standards such as Peripheral Component Interconnect (PCI), Peripheral Component Interconnect Express (PCIe), Bluetooth, etc. The system(s) and method(s) of the present disclosure provide a solution in which users are no longer forced to search for drivers on the web, and OS developers are no longer forced to store huge quantities of drivers on the OS.

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of a firmware package and/or a software package. Such a firmware package and/or software package may be a computer program product which employs a computer-readable storage medium including stored computer code which is used to program a computer to perform the disclosed function and process of the present invention. The computer-readable medium/computer-readable storage medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method of operation of a host system, the method comprising:
determining if a desired driver is present within the host system;
when the desired driver is not present within the host system, directing a query to a device connected to the host system to determine if the desired driver is present within on-board memory of the device;
receiving a response to the query, the response being provided by the device, the response indicating that the desired driver is present within the on-board memory of the device; and
based upon the received response, determining a location within the on-board memory of the device where the desired driver on the device is stored; and
uploading the desired driver from the determined location of the on-board memory of the device to the host system.

2. A method as claimed in claim 1, the method further comprising:
loading the desired driver via an operating system of the host system.

3. A method as claimed in claim 2, the method further comprising:
communicating with the device via the operating system of the host system by utilizing the desired driver.

4. A method as claimed in claim 3, the method further comprising:
downloading an updated version of the desired driver from a disk or via the Internet to the host system.

5. A method as claimed in claim 4, the method further comprising:
identifying the updated version of desired driver.

6. A method as claimed in claim 5, the method further comprising:
selecting the identified updated version of the desired driver.

7. A method as claimed in claim 6, the method further comprising:
downloading the updated version of the desired driver from the host system to the device.

8. A non-transitory, computer-readable medium having computer-executable instructions for performing a method of operation of a host system, said method comprising:
determining if a desired driver is present within the host system;
when the desired driver is not present within the host system, directing a query to a device connected to the host system to determine if the desired driver is present within on-board memory of the device;
receiving a response to the query, the response being provided by the device, the response indicating that the desired driver is present within the on-board memory of the device; and
based upon the received response, determining a location within the on-board memory of the device where the desired driver on the device is stored; and
uploading the desired driver from the determined location of the on-board memory of the device to the host system.

9. A non-transitory, computer-readable medium having computer-executable instructions for performing a method as claimed in claim 8, said method further comprising:
loading the desired driver via an operating system of the host system.

10. A non-transitory, computer-readable medium having computer-executable instructions for performing a method as claimed in claim 9, said method further comprising:
communicating with the device via the operating system of the host system by utilizing the desired driver.

11. A non-transitory, computer-readable medium having computer-executable instructions for performing a method as claimed in claim 10, said method further comprising:
downloading an updated version of the desired driver from a disk or via the Internet to the host system.

12. A non-transitory, computer-readable medium having computer-executable instructions for performing a method as claimed in claim 11, said method further comprising:
identifying the updated version of desired driver.

13. A non-transitory, computer-readable medium having computer-executable instructions for performing a method as claimed in claim 12, said method further comprising:
selecting the identified updated version of the desired driver.

14. A non-transitory, computer-readable medium having computer-executable instructions for performing a method as claimed in claim 13, said method further comprising:
downloading the updated version of the desired driver from the host system to the device.

15. A method of operation of a host system, the method comprising:
determining if a desired driver is present within the host system;
when the desired driver is not present within the host system, directing a query to a device connected to the host system to determine if the desired driver is present within on-board memory of the device;
receiving a response to the query, the response being provided by the device, the response indicating that the desired driver is present within the on-board memory of the device;
based upon the received response, determining a location within the on-board memory of the device where the desired driver on the device is stored;
uploading the desired driver from the determined location of the on-board memory of the device to the host system;
loading the desired driver via an operating system of the host system;
communicating with the device via the operating system of the host system by utilizing the desired driver;
downloading an updated version of the desired driver from a disk or via the Internet to the host system;
identifying the updated version of desired driver;
selecting the identified updated version of the desired driver; and
downloading the updated version of the desired driver from the host system to the device.
